(19) United States
(12) Patent Application Publication
(10) Pub. No.: US 2017/0102707 A1
(43) Pub. Date: Apr. 13, 2017

(54) METHOD FOR OPERATING A DRIVER ASSISTANCE SYSTEM FOR AUTOMATICALLY GUIDING A MOTOR VEHICLE, AND PAIRED MOTOR VEHICLE

(71) Applicant: AUDI AG, Ingolstadt (DE)

(72) Inventors: Michael Reichel, Ingolstadt (DE); Christian Rösener, Hille (DE)

(21) Appl. No.: 15/316,066

(22) PCT Filed: Apr. 24, 2015
(86) PCT No.: PCT/EP2015/000847

§ 371 Date: Dec. 2, 2016

(30) Foreign Application Priority Data
Jun. 4, 2014 (DE) 10 2014 008 353.5

(51) Int. Cl. G05D 1/02; G08G 1/16; B60W 10/184; B60W 10/20; B60W 30/095; B60W 10/06

(52) U.S. Cl. CPC G05D 1/0219; B60W 30/0956; B60W 10/06; B60W 10/184; B60W 10/20; G08G 1/16; G05D 2201/0213; B60W 2420/52; B60W 2420/42; B60W 2550/10; B60W 2720/24

(57) ABSTRACT

A method for operating a driver assistance system for the automated guidance of a motor vehicle, comprising the steps:
Detecting environmental data relating to the surroundings of the motor vehicle by environmental sensors of the motor vehicle as well as ego data relating to the motor vehicle,
Determining several trajectories that respectively describe a possible future movement of the motor vehicle depending on the environmental data and the ego data,
Selecting a reference trajectory from the determined trajectories by analyzing several evaluation criteria, wherein at least one of the evaluation criteria is a detection range criterion that analyzes at least one predicted detection range of one of the environmental sensors or of a group of the environmental sensors of the motor vehicle during a predicted movement of the motor vehicle along the respective determined trajectory,
Controlling vehicle systems in order to move the motor vehicle along the reference trajectory.

The invention relates to a method for operating a driver assistance system for the automated guidance of a motor vehicle.

Methods for the automated, in particular highly automated, guidance of motor vehicles can be divided into three phases. First, the detection phase occurs, i.e. an acquisition of information relevant to the planning of future driving maneuvers. Based on this information, a path or trajectory planning is performed in a second phase, the behavior planning and decision-making phase. In a third phase, a behavior implementation takes place, wherein vehicle systems are controlled in order to implement the previously planned path or trajectory.

Sensors of the vehicle sensor system have a limited range and a limited opening angle. It is thus possible that regions of the surroundings that would be relevant for a path or trajectory planning are not detected during the detection phase by the vehicle sensor system and thus can also not be taken into consideration in the path or trajectory planning.

From document DE 10 2011 002 911 A1 is known a method for guiding a vehicle in a lane, wherein the vehicle is guided in the lane by means of automatic steering interventions. In order to warn the driver in good time before a failure of the lane keeping system, it is proposed to analyze data regarding an upcoming route section and to determine therefrom whether a specified system limit is exceeded when driving through the route section. A system limit can, for example, arise from the technical capacity of system components used. For example, in very tight curves, lane markings on the road can no longer be detected due to the limited horizontal angle detection range of a video sensor system. If a possible exceedance of a specified system limit is determined, a signal is output to the driver warning the driver of an upcoming failure of the lane keeping system and prompting him to take control via the steering wheel.

Document DE 10 2012 007 127 A1 relates to a method for determining a path of movement for a vehicle. In this method, a lane boundary and several possible paths of movement for the vehicle are determined. A path of movement is selected from the several possible paths of movement depending on the dimensions of the distance spaces.

Document US 2008/0 065 328 A1 discloses a method for collision avoidance for a vehicle. Data that relate to a set of objects external to the vehicle are detected by sensors of the motor vehicle. These data respectively include an object position and an object velocity. Probable trajectories are predicted for the external objects. These trajectories can be used to predict potential conflicts and to initiate control interventions.

The invention is thus based on the task of specifying a method for operating a driver assistance system for the automated guidance of a motor vehicle, which system is improved in comparison with respect to the detection of relevant surrounding regions during an automated driving operation.

The task is achieved according to the invention by a method of the aforementioned type comprising the following steps:
Detecting environmental data relating to the surroundings of the motor vehicle by environmental sensors of the motor vehicle as well as ego data relating to the motor vehicle,
Determining several trajectories that respectively describe a possible future movement of the motor vehicle depending on the environmental data and the ego data,
Selecting a reference trajectory from the determined trajectories by analyzing several evaluation criteria, wherein at least one of the evaluation criteria is a detection range criterion that analyzes at least one predicted detection range of one of the environmental sensors or of a group of the environmental sensors of the motor vehicle during a predicted movement of the motor vehicle along the respective determined trajectory,
Controlling vehicle systems in order to move the motor vehicle along the reference trajectory.

It is proposed according to the invention to select the reference trajectory on which the motor vehicle is to be guided during an automated guidance such that at least one detection range of one of the environmental sensors or of a group of the environmental sensors is taken into consideration during the predicted movement of the motor vehicle along the reference trajectory. In addition to the evaluation criteria that are generally analyzed within the scope of the determination of a reference trajectory and take into consideration, for example, dynamic driving parameters of the motor vehicle, the distance of the motor vehicle to other objects and similar, which are respectively predicted for one of the trajectories, additional predicted detection ranges of sensors or sensor groups are to be taken into consideration. With this approach, the reference trajectory can be selected such that surrounding regions identified as being relevant are reliably detected during the movement of the motor vehicle along the reference trajectory.

The method according to the invention can in particular be used in a highly or fully automated guidance of the motor vehicle by means of the driver assistance system. Even a driver assistance system for the partially automated guidance of the motor vehicle can however advantageously use the method according to the invention. The classification of the degrees of automation in this respect is based on the publication of the Federal Highway Research Institute “Forschung Kompakt November 2012—Rechtsfolgen zunehmender Fahrzeugautomatisierung” [Research Compact November 2012—Legal consequences of an increase in vehicle automation]. According to this publication, the driver assistance system completely takes over the lateral and longitudinal control in a defined case of application during a fully automated drive. In the process, the driver does not need to monitor the system. During a highly automated drive, the driver assistance system takes over the lateral and longitudinal control for a certain period of time in specific situations. In this case, the driver also does not need to monitor the system. When needed, the driver is prompted with a sufficient time reserve to take over the driving tasks. During a partially automated drive, the driver assistance system takes over the lateral and longitudinal control for a certain period of time and/or in specific situations. The driver has to monitor the system continuously.

In the method according to the invention, a variety of sensors, such as cameras, ultrasonic sensors, or radar sensors can be used as environmental sensors. The ego data can be detected by internal sensors of the motor vehicle. It is also possible to analyze control parameters that are provided by the driver assistance system itself or by additional motor vehicle systems as ego data of the motor vehicle or to take ego data from a database that in particular contains map data.

A detection range of a single environmental sensor can, for example, be defined by a maximum sensor range and an opening angle. In order to determine a detection range during the predicted movement of the motor vehicle along a respective trajectory, in particular coordinate transformation functions between environment-related, vehicle-related, and/or sensor-related coordinate systems can be used. In the process, the detection range of a sensor itself can be specified in a coordinate system associated with the sensor. By means of a known orientation and a known place of arrangement on the motor vehicle, a conversion of this detection range into a motor vehicle-related coordinate system is possible. The motor vehicle-related coordinate system can be defined according to DIN 70000. For the trajectory planning, it can however be advantageous to instead use an environmental sensor coordinate system. The x-y plane of the environmental sensor coordinate system can be defined by the contact areas of the wheels on the ground. The x-axis points forward in the longitudinal direction of the vehicle. The origin lies in the contact area in the center of the rear axle. The yaw angle, pitch angle, and roll angle of a motor vehicle are taken into consideration as angles of rotation. In doing so, the configuration space in the trajectory planning can advantageously be related to the environmental sensor coordinate system, and detected environmental data can be transformed for the trajectory planning into the environmental sensor coordinate system.

In order to determine, for example, whether a position during a movement of the motor vehicle along a trajectory is within the detection range of an environmental sensor, the position to be checked can initially be described in the current environmental sensor coordinate system. By means of a coordinate transformation, for example by the application of an appropriate rotation matrix and by a translation, the coordinates of the position can be converted into a predicted environmental sensor coordinate system for a stop of the motor vehicle at a trajectory point located on the trajectory. By means of a second coordinate transformation, the coordinates of the position can then be converted into a predicted sensor coordinate system and it can be determined, for example by a comparison of point coordinates with an opening angle of the sensor and a range of the sensor, whether the respective point is within the detection range of the sensor.

Advantageously, at least one relevant environmental element in the surroundings of the motor vehicle can be determined prior to selecting the reference trajectory, wherein the detection criterion is analyzed as to what extent the relevant environmental element is located within the predicted detection range during the respective predicted movement. The environmental element can be a fixed environmental element with respect to the surroundings of the motor vehicle location, such as a crossing or an intersection. Alternatively or supplementary, moving environmental elements, such as other motor motor vehicles or pedestrians, can also be taken into consideration as relevant environmental elements. For a consideration of relevant moving environmental elements, a future element trajectory can be predicted for the respective relevant moving environmental element. For the predicted movement of the motor vehicle along a respective trajectory, it can respectively be determined in this case at what point in time a trajectory point is reached, and a predicted position of the relevant moving environmental element can be determined depending on the element trajectory and the point in time.

The determined trajectories for a possible future movement of the motor vehicle can in particular respectively include several trajectory points that are temporally spaced apart, wherein a point detection range criterion is determined for each of the trajectory points of each of the determined trajectories, wherein a predicted detection range is determined for each of the trajectory points, and wherein the point detection range criterion is respectively fulfilled if the relevant environmental element is located at least partially in the respective predicted detection range. The detection range criterion can be fulfilled if the proportion and/or the number of trajectory points of the respective determined trajectory for which the point detection range criterion is fulfilled exceeds or reaches a specified value. The detection range criterion can in particular be fulfilled if the point detection range criterion is fulfilled for all of the trajectory points of the respective determined trajectory.

In the method according to the invention, one of the determined trajectories, for which the detection range criterion is fulfilled, can in particular be selected as reference trajectory. For this purpose, either trajectories, for which the detection range criterion is fulfilled, or trajectories, for which the detection range criterion is not fulfilled, can in particular be marked by a so-called flag, i.e. by a certain state of a variable that can in particular have two states. In the further process, only such trajectories, for which the flag was set or not set, can be taken into consideration in the determination of the reference trajectory.

It would be possible alternatively for a non-fulfillment of the detection range criterion to only result in a downgrading of the respective trajectory, for which it is not fulfilled, with respect to trajectories, for which it is fulfilled. In particular, depending on the different evaluation criteria for the selection of the reference trajectory, a value of the trajectory can respectively be determined for each of the trajectories, wherein the trajectory with the highest or the lowest value is selected as reference trajectory. For example, the detection range criterion can be taken into consideration in the determination of the value of the respective trajectory such that a specified value is respectively added to the value of the trajectory when the detection range criterion is fulfilled. Naturally, more complex operations of several evaluation criteria are also possible for the selection of the reference trajectory. For example, at least two detection range criteria can respectively be determined for an environmental sensor or a group of environmental sensors, and from the selection of the reference trajectory can be excluded only such trajectories, for which both detection range criteria are not fulfilled.

The determined trajectories can respectively include several trajectory points that are temporally spaced apart, wherein a point evaluation criterion is respectively analyzed for each of the trajectory points for at least one of the evaluation criteria in order to determine a point evaluation, wherein the point evaluation criterion analyzes the point evaluation criteria associated with the respective determined trajectory. A time discretization of the predicted movement of the motor vehicle along the respective determined trajectory thus takes place. For each of these discrete points in time, i.e. the trajectory points, a point evaluation criterion is analyzed separately in order to determine the respective evaluation criterion.

The invention furthermore relates to a motor vehicle with a driver assistance system for the automated guidance of a motor vehicle, wherein the motor vehicle is designed to perform the method according to the invention.

The following exemplary embodiments and the associated drawings show additional advantages and details of the invention. The following is shown schematically:

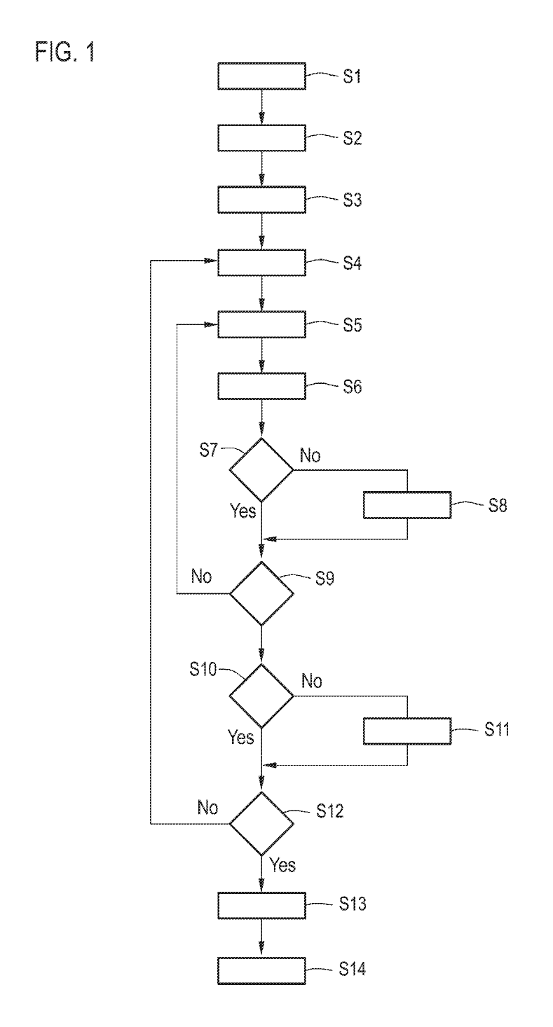

FIG. 1 a flowchart of an exemplary embodiment of the method according to the invention,

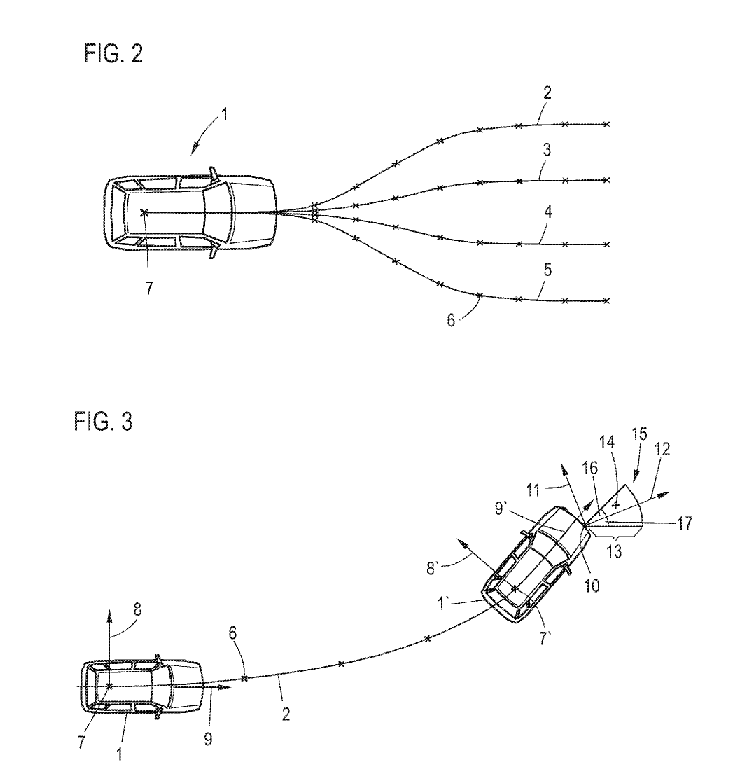

FIG. 2 an illustration of several trajectories determined for a motor vehicle in an exemplary embodiment of the method according to the invention,

FIG. 3 a predicted detection range of a sensor during a movement of a motor vehicle along one of the trajectories shown in FIG. 2, and

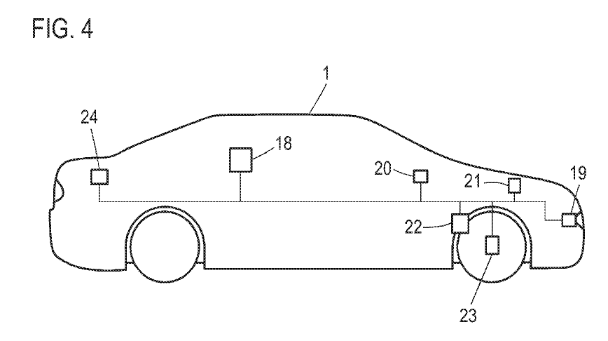

FIG. 4 an exemplary embodiment of a motor vehicle according to the invention.

FIG. 1 schematically shows a flowchart of a method for operating a driver assistance system for the automated guidance of a motor vehicle. In step S1, the environmental data relating to the surroundings of the motor vehicle are determined by environmental sensors of the motor vehicle, and ego data relating to the motor vehicle itself are determined by additional sensors of the motor vehicle, the analysis of control parameters, and the analysis of databases. In order to generate an environmental model of the surroundings of the motor vehicle and to allow for trajectory planning, environmental data detected by different environmental sensors are transformed into a common coordinate system, the so-called environmental sensor coordinate system. The environmental sensor coordinate system is used for further trajectory planning.

Depending on the environmental and ego data determined in step S1, several trajectories, which respectively describe a possible future movement of the motor vehicle, are determined in step S2. Such determined trajectories 2, 3, 4, 5 are shown schematically in FIG. 2. Starting from the motor vehicle 1, four determined trajectories 2, 3, 4, 5 that describe the possible future movements of the motor vehicle are illustrated schematically. For reasons of clarity, only the four trajectories 2, 3, 4, 5 are shown. In typical driving situations, many more trajectories are determined by the driver assistance system for the automated guidance. Each of the trajectories 2, 3, 4, 5 includes trajectory points 6 that are temporally spaced apart and that describe a respective position of the origin 7 of the environmental sensor coordinate system and thus of the motor vehicle 1. During the determination of the trajectories 2, 3, 4, 5 in step S2, additional information regarding the predicted state of the motor vehicle 1, in particular a predicted orientation of the motor vehicle 1 at the respective trajectory point 6, is also determined for each of the trajectory points 6 in addition to the positions of the respective trajectory points 6 in the current environmental sensor coordinate system.

In step S3, at least one relevant environmental element in the surroundings of the motor vehicle is determined from the environmental data detected in step S1, wherein the guidance of the motor vehicle is to be carried out such that the environmental element remains within the detection range of a sensor of the motor vehicle. The environmental element can, for example, be a fixed point in the surroundings of the motor vehicle, which point marks a crossing or the end of a lane, for example. The environmental element can however also be a moving environmental element, such as another motor vehicle or a pedestrian.

If the environmental element is a moving environmental element, a movement prediction for the environmental element is additionally performed in step S3, wherein for the points in time, for which a trajectory point 6 was respectively determined in step S2, a predicted position of the environmental element in the current environmental sensor coordinate system is determined.

The result of step S3 is a fixed coordinate or a coordinate that varies between the different trajectory points 6 for at least one relevant environmental element in the current environmental sensor coordinate system. In the following steps, the reference trajectory is now to be selected from the determined trajectories 2, 3, 4, 5 such that the respective coordinate is within the predicted detection range of the environmental sensor during a movement of the motor vehicle along the reference trajectory.

For this purpose, a detection criterion is analyzed in steps S4-S12 for each of the trajectories 2, 3, 4, 5. The steps S4-S12 are performed separately for each of the trajectories 2, 3, 4, 5 determined in step S2. For this reason, one of the determined trajectories 2, 3, 4, 5, for which the steps S5-S12 are subsequently performed, is first selected in step S4 for each pass.

The detection range criterion is determined depending on point detection range criteria that are determined separately in the steps S5-S9 for each of the trajectory points 6 of the respective trajectory 2, 3, 4, 5. For this purpose, one of the trajectory points 6 of the trajectory 2, 3, 4, 5 selected in step S4 is respectively selected in step S5 for each pass of the steps S5-S9, for which trajectory point the point detection range criterion is determined in the following steps.

In order to determine whether the coordinate of the relevant environmental element is within a predicted detection range of the sensor for the respective selected trajectory point 6, the coordinate of the relevant environmental element is transformed from the current environmental sensor coordinate system into a predicted sensor coordinate system. This transformation, which is explained in more detail below with reference to FIG. 3, takes place in two steps, wherein the coordinate of the relevant environmental element 14 is transformed first from the current environmental sensor coordinate system into a predicted environmental sensor coordinate system and then from the predicted environmental coordinate system into the predicted sensor coordinate system. The current environmental sensor coordinate system has its origin 7 in the center of the rear axle in the contact area, on which the motor vehicle 1 stands. The x-y plane of the environmental sensor coordinate system is defined by the contact area of the wheels on the ground. The x-axis 8 extends orthogonally to the driving direction, and the y-axis 9 extends in the driving direction. The trajectory 2 of the trajectories 2, 3, 4, 5 illustrated in FIG. 2 is considered as the trajectory selected in step S4. Several of the trajectory points 6 are shown along the trajectory 2. For each of the trajectory points 6, a position of the motor vehicle 1 and an orientation of the motor vehicle, i.e. a yaw angle, was determined in step S2 as part of the trajectory calculations.

For the trajectory point 6 selected in step S5, a predicted environmental sensor coordinate system with the origin 7′ is determined according to the predicted vehicle position 1′. The x-axis 8′ of the predicted environmental sensor coordinate system extends orthogonally to the predicted driving direction of the motor vehicle at the trajectory point 6; the direction of the y-axis 9′ of the predicted environmental sensor coordinate system extends in the predicted driving direction. Since both the location of the origin 7 as well as the location of the x- and y-axis 8, 9 of the environmental sensor coordinate system and the location of the origin 7′ as well as the location of the x- and y-axis 8′, 9′ of the predicted environmental sensor coordinate system are known, a coordinate of a relevant environmental element 14 can be transformed by a coordinate transformation from the current environmental sensor coordinate system into the predicted environmental sensor coordinate system. Such a transformation is, for example, possible by the application of an appropriate rotation matrix to the coordinates and by a subsequent translation.

Subsequently, the coordinate of the relevant environmental element 14 is transformed into a sensor coordinate system that has its origin at the point 10 and is spanned by the x-axis 11 and the y-axis 12. The location of the predicted sensor coordinate system relative to the predicted environmental sensor coordinate system exclusively depends on the relative locations and the orientation of the sensor in the motor vehicle 1.

After the coordinate transformations, the coordinates of the relevant environmental element in the predicted sensor coordinate system are available in step S7. This is why it can be particularly easily determined in step S7 whether the coordinates of the relevant environmental element 14 are within a detection range 15 of the sensor. A detection range of a sensor can be described for most sensors by two delimiting angles of the opening angle, α_{Start′} 16, α_{End} 17, and by a maximum sensor range R 13. The coordinates of the relevant environmental element 14 are within the detection range of the sensor if on the one hand, the following applies:

R≧\sqrt{x²+y²},

where x and y are the coordinates of the relevant environmental element in the predicted sensor coordinate system. On the other hand, the following must apply:

α_{Start}<arctan(y:x)≦α_{End}.

If one of these two conditions is not fulfilled, the relevant environmental element 14 is outside the detection range and the method is continued with step S8, in which the trajectory point 6 selected in step S5 of the trajectory 2, 3, 4, 5 selected in step S4 is marked by setting a flag, since the point detection range criterion is not fulfilled.

If both conditions were fulfilled in step S7 or if the marking took place in step S8, it is checked in step S9, whether all trajectory points 6 of the trajectory 2, 3, 4, 5 selected in step S4 were already processed. If this is not the case, the method is continued with step S5, and another trajectory point 6 of the trajectory 2, 3, 4, 5 selected in step S4 is selected.

If it was determined in step S9 that all trajectory points 6 of a trajectory 2, 3, 4, 5 were processed, it is determined for this trajectory 2, 3, 4, 5 in step S10 whether the detection range criterion is fulfilled. The detection range criterion is fulfilled for a trajectory 2, 3, 4, 5, if all point detection range criteria are fulfilled, i.e. if none of the trajectory points 6 was marked in step S8 by setting a flag.

In an alternative embodiment, it could be sufficient for fulfilling the detection range criterion if the point detection range criterion is respectively fulfilled for a specified number or a specified proportion of trajectory points 6.

If the detection range criterion is not fulfilled, the trajectory 2, 3, 4, 5 selected in step S4 is marked by setting a trajectory flag in order to indicate that the detection range criterion was not fulfilled for this trajectory 2, 3, 4, 5. Subsequently, it is checked in step S12 whether all trajectories 2, 3, 4, 5 determined in step S2 were already processed.

If this is not the case, the method is continued in step S4, and another one of the determined trajectories 2, 3, 4, 5 is selected. If all determined trajectories 2, 3, 4, 5 were already checked as to whether the detection range criterion is respectively fulfilled for them, the method is continued in step S13, in which one of the trajectories 2, 3, 4, 5, for which the trajectory flag was not set in step S11, i.e. for which the detection range criterion is fulfilled, is selected as reference trajectory depending on additional evaluation criteria. A selection of one of several trajectories 2, 3, 4, 5 as the reference trajectory to be used in the method for the automated guidance of a motor vehicle is basically known from the prior art and is not to be explained in more detail.

The selected reference trajectory is subsequently executed in step S14 by controlling vehicle systems in order to move the motor vehicle along the reference trajectory.

FIG. 4 shows a motor vehicle 1 that is designed to perform the method explained above. The motor vehicle comprises a driver assistance system 18 for the automated guidance of the motor vehicle 1. By means of the environmental sensor 19, environmental data relating to the surroundings of the motor vehicle are detected. At the same time, using numerous sensors not shown as well as using the GPS receiver 24 in connection with the navigation system 20, ego data of the motor vehicle are detected, which ego data describe the vehicle state and in particular the position of the motor vehicle.

An automated guidance of the motor vehicle 1 by the driver assistance system 18 is possible by the driver assistance system 18 controlling various vehicle systems, in particular the engine 21, the brakes 22, and the steering 23 in order to guide the motor vehicle on a reference trajectory 24 determined by the driver assistance system 18. For this purpose, as explained above, several trajectories that respectively describe a possible future movement of the motor vehicle are determined depending on the environmental data and the ego data. One of these determined trajectories is selected as reference trajectory for the guidance of the motor vehicle, wherein the detection range of the environmental sensor 19 is taken into consideration in the selection of the reference trajectory.

1. A method for operating a driver assistance system for the automated guidance of a motor vehicle, comprising:
detecting environmental data relating to surroundings of the motor vehicle by environmental sensors of the motor vehicle and ego data relating to the motor vehicle;
determining several trajectories that respectively describe a possible future movement of the motor vehicle depending on the environmental data and the ego data;
selecting a reference trajectory from the determined trajectories by analyzing several evaluation criteria, wherein at least one of the evaluation criteria is a detection range criterion that analyzes at least one predicted detection range of one of the environmental sensors or of a group of the environmental sensors of the motor vehicle during a predicted movement of the motor vehicle along the respective determined trajectory; and
controlling vehicle systems in order to move the motor vehicle along the reference trajectory.

2. The process according to claim 1 wherein at least one relevant environmental element in the surroundings of the motor vehicle is determined prior to selecting the reference trajectory, wherein the detection criterion is analyzed as to what extent the relevant environmental element is located within the predicted detection range during the respective predicted movement.

3. The process according to claim 2 wherein the determined trajectories respectively include several trajectory points that are temporally spaced apart, wherein a point detection range criterion is determined for each of the trajectory points of each of the determined trajectories, wherein a predicted detection range is determined for each of the trajectory points, and wherein the point detection range criterion is respectively fulfilled if the relevant environmental element is located at least partially in the respective predicted detection range.

4. The process according to claim 3 wherein the detection range criterion is fulfilled if the proportion and/or the number of trajectory points of the respective determined trajectory, for which the point detection range criterion is fulfilled, exceeds or reaches a specified value.

5. The process according to claim 4 wherein one of the determined trajectories, for which the detection range criterion is fulfilled, is selected as reference trajectory.

6. The process according to claim 1 wherein the determined trajectories respectively include several trajectory points that are temporally spaced apart, wherein a point evaluation criterion is respectively analyzed for each of the trajectory points for at least one of the evaluation criteria in order to determine a point evaluation, wherein the evaluation criterion analyzes the point evaluation criteria associated with the trajectory points of the respective determined trajectory.

7. A motor vehicle comprising a driver assistance system for the automated guidance of the motor vehicle, the motor vehicle is designed to perform the method of claim 1.
